(19) United States
(12) Patent Application Publication
(10) Pub. No.: US 2022/0065794 A1
(43) Pub. Date: Mar. 3, 2022

(54) SYSTEM AND METHOD FOR LOGISTICS MANAGEMENT BASED ON ODOR MOLECULES

(71) Applicant: TAIWAN CARBON NANO TECHNOLOGY CORPORATION, MIAOLI COUNTY (TW)

(72) Inventors: Ching-Tung HSU, MIAOLI COUNTY (TW); Chao-Chieh LIN, MIAOLI COUNTY (TW); Yuan-Shin HUANG, MIAOLI COUNTY (TW); Chia-Hung LI, MIAOLI COUNTY (TW); Wen-Hui LIU, MIAOLI COUNTY (TW); Chun-Hsien TSAI, MIAOLI COUNTY (TW); Ting-Chuan LEE, MIAOLI COUNTY (TW); Chun-Jung TSAI, MIAOLI COUNTY (TW)

(21) Appl. No.: 17/412,894

(22) Filed: Aug. 26, 2021

(30) Foreign Application Priority Data
Aug. 26, 2020 (TW) 109129156

(51) Int. Cl. G01N 21/78; G06Q 50/28

(52) U.S. Cl. CPC G01N 21/78; G06Q 50/28

(57) ABSTRACT

A system for logistics management based on odor molecules is provided. The system includes a sensor, an information device and a server. The sensor is arranged on an item to be tracked, and includes a colorimetric sensor array and a material which stores and releases molecules, wherein the material releases an odor molecule. The colorimetric sensor array includes a plurality of sensing materials. The plurality of sensing materials reacts with at least one metabolic molecule of the odor molecule to enable the colorimetric sensor array to present a color pattern. The information processing device includes an image capturing element for obtaining the color pattern and a transceiver for transmitting the color pattern. The server stores a database. The color pattern and the database are compared to generate a comparison result.

### FIELD OF THE INVENTION

The invention relates to a system and method for providing item identification, and particularly relates to a system and method for logistics management based on odor molecules.

### BACKGROUND OF THE INVENTION

In recent years, with the rapid development of the globalization tendency, distribution and mobility of supply chains and e-commerce have been greatly improved, which has jointly promoted the growth of the logistics industry. The transportation routes of commodities, goods or raw materials are becoming more and more complicated, and the difficulty in management is also increasing. Therefore, how to manage the various items reliably and safely is an urgent issue for improvement.

### SUMMARY OF THE INVENTION

The invention mainly aims to improve the reliability and safety in logistics management.

In order to achieve the above purpose, the invention provides a system for logistics management based on odor molecules, including a sensor mounted on an item to be tracked, wherein the sensor comprises a colorimetric sensor array and a material which stores and releases molecules, the material is configured to pre-store at least one known odor molecule, and the colorimetric sensor array includes a plurality of sensing materials sensing the at least one odor molecule, wherein a combination of the at least one odor molecule and the plurality of sensing materials is associated with the item to be tracked; an information processing device including an image capturing element and a transceiver; and a server storing a database, wherein a communication connection is established between the server and the information processing device. The system is configured to perform the following steps: a reaction occurred when at least one metabolic molecule of the odor molecule released from the material is combined with the sensing materials such that an initial color of the colorimetric sensor array is changed into an indicator color to present a color pattern, and appearing a color pattern by the colorimetric sensor array; capturing an image of the color pattern by the image capturing element of the information processing device; comparing the image with the database to generate a comparison result; and providing an identification result corresponding to the item to be tracked based on the comparison result by the information processing device.

In order to achieve the above purpose, the invention further provides a method for logistics management based on odor molecules, including the following steps: providing an item to be tracked, wherein the item to be tracked is provided with a sensor including a colorimetric sensor array and a material which stores and releases molecules, the colorimetric sensor array includes a plurality of sensing materials sensing the odor molecules, the material pre-stores at least one known odor molecule, and a selection of the at least one odor molecule and the plurality of sensing materials is associated with the item to be tracked; a reaction occurred when at least one metabolic molecule of the odor molecule released from the material is combined with the sensing materials such that an initial color of the colorimetric sensor array is changed into an indicator color to present a color pattern, and appearing a color pattern by the colorimetric sensor array; comparing the color pattern with a default pattern to generate a comparison result; and providing an identification result corresponding to the item to be tracked based on the comparison result by the information processing device.

In order to achieve the above purpose, the invention further provides a method for logistics management based on odor molecules, including the following steps: providing an item to be tracked, wherein the item to be tracked is provided with a sensor including a colorimetric sensor array and a material which stores and releases molecules, the colorimetric sensor array includes a plurality of sensing materials sensing odor molecules, the material pre-stores at least one known odor molecule, and a selection of the at least one known odor molecule and the plurality of sensing materials is associated with the item to be tracked; releasing a first odor molecule from the material, and a first reaction occurred when at least one first metabolic molecule of the first odor molecule is combined with the sensing materials such that an initial color of the colorimetric sensor array is changed into a first indicator color to present a first color pattern; comparing the first color pattern with a default pattern to generate a first comparison result; releasing a second odor molecule from the material after a period of time, and a second reaction occurred when at least one second metabolic molecule of the second odor molecule released from the material is combined with the sensing materials such that the first indicator color of the colorimetric sensor array is changed into a second indicator color to present a second color pattern; comparing the second color pattern with the default pattern to generate a second comparison result; and providing an identification result corresponding to the item to be tracked based on the first comparison result and the second comparison result by the information processing device.

Accordingly, in the invention, by use of the combination of the material which stores and releases molecules and the colorimetric sensor array, the odor molecule corresponding to the item to be tracked is pre-stored in the material, and the colorimetric sensor array provides macroscopic information. In this way, information associated with the item to be tracked is obtained via the color pattern, so as to manage the item to be tracked. The odor molecule stored in the material is hard to change and access, so that high level of safety is achieved. Furthermore, by selecting a proper material, the odor molecule can be designed to change over time and form different color patterns accordingly, thus further improving the safety of logistics management.

### BRIEF DESCRIPTION OF THE DRAWINGS

FIG. 1 is a schematic diagram of a system architecture of one embodiment of the invention.

FIG. 2 is a schematic structural diagram of a sensor in one embodiment of the invention.

FIG. 3 is a schematic structural diagram of a sensor in another embodiment of the invention.

FIG. 4 is a schematic diagram of an application of one embodiment of the invention.

FIG. 5 is a flow chart of steps of a method of one embodiment of the invention.

FIG. 6 is a flow chart of steps of a method of another embodiment of the invention.

### DETAILED DESCRIPTION OF THE PREFERRED EMBODIMENTS

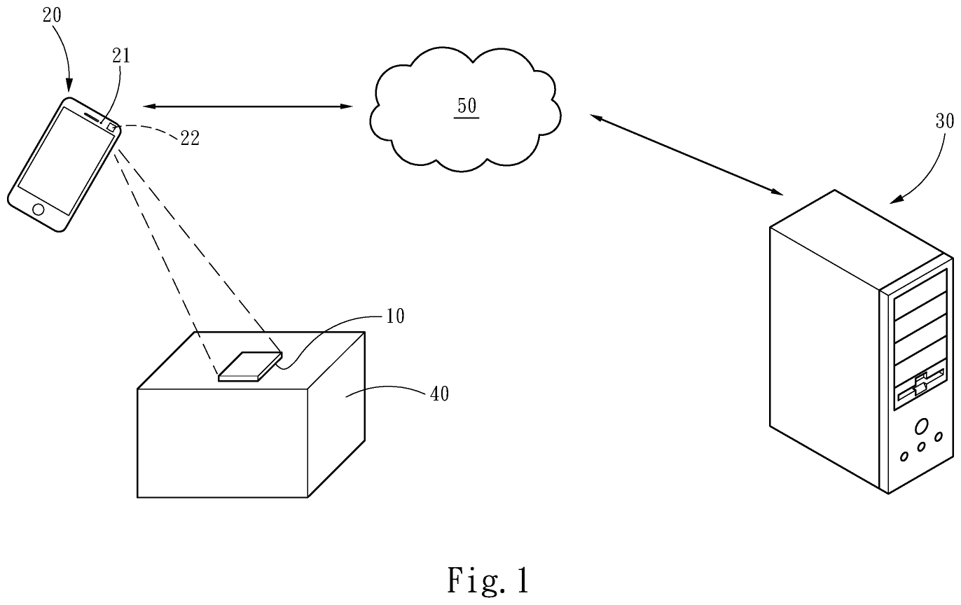

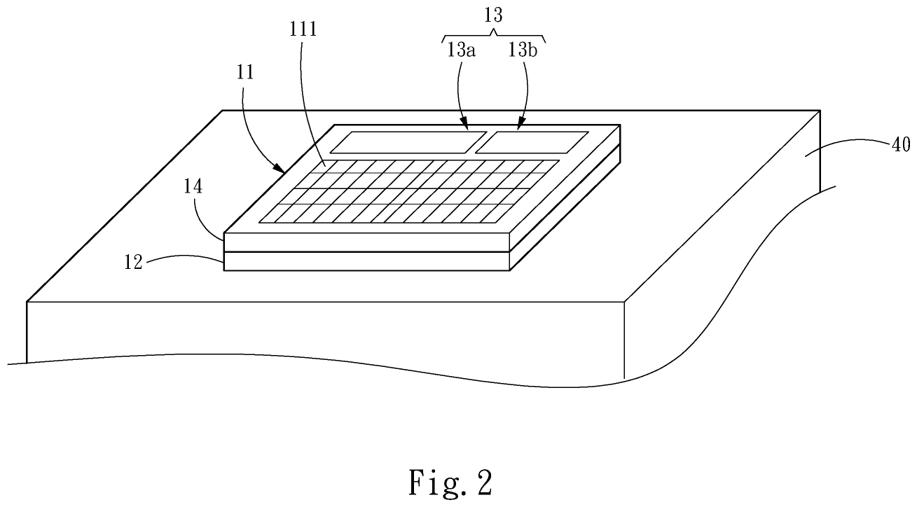

Referring to FIG. 1, the invention provides a system for logistics management based on odor molecules, including a sensor 10, an information processing device 20 and a server 30. The sensor 10 is mounted on an item 40 to be tracked. FIG. 2 is a schematic structural diagram of the sensor 10 in one embodiment. The sensor 10 includes a colorimetric sensor array 11, a material 12 which is configured to pre-store and release molecules and at least one information display area 13. The colorimetric sensor array 11 includes a plurality of sensing materials 111. The plurality of sensing materials 111 is regarded as sensing pixels. In this example, the colorimetric sensor array 11 and the at least one information display area 13 are arranged on a substrate14. The substrate 14 is arranged on the material 12. The material 12 is attached to the item 40 to be tracked. In the invention, the plurality of sensing materials 111 reacts with at least one metabolic molecule of an odor molecule released from the material 12 to generate an recognizable color change. The correspondence between a color appeared after the reaction of the odor molecule (and/or the metabolic molecule) and the plurality of sensing materials 111 is known.

In one embodiment, the plurality of sensing materials 111 includes a color reagent. The color reagent is selected from a group consisting of methyl red, Congo red, bromophenol blue, bromocresol purple, bromocresol green, cresol red, phenol red, thymolphthalein, resazurin, paranitrophenol, bromothymol blue, thymol blue, neutral red, crystal violet, 4-(4-nitrobenzyl) pyridine, pyrocatechol violet, chlorophenol red, nitrazine yellow, bromophenol red, in-cresol purple, Eriochrome black T, safranine, luciferin, Eosin yellow, Brilliant green, Titan yellow, Victoria blue B, carmine, litmus, curcumin, anthocyanin, alizarin red S, alizarin yellow R, indigo carmine, nile blue A, orange yellow G, Eosin B, 3,3′,5,5′,-tetraiodophenol sulfone phenolphthalein, bromoxylenol blue, phenol blue, disperse orange 25, acridine orange, disperse orange 3, disperse red 1, bromopyrogallol red, diaminodiphenyl sulfone, aminofluorescein, ammonium purpurate, 2,6-dichloroindophenol, sodium salts thereof, and mixtures thereof. The plurality of sensing materials 111 includes a molecular barrier material. The molecular barrier material is selected from a group consisting of octadecanol, polyvinylpyrrolidone, polyvinyl formal, polyvinyl acetate resin, phenolic resin, epoxy resin, polybutene resin, polyethylene glycol, carbon black, carbon nanotubes, graphene, cellulose nanofibers, silicone compounds, and mixtures thereof. The molecular barrier material is mixed with the color reagent to form a sensing pixel, or the molecular barrier material is coated on the color reagent to form the sensing pixel. The molecular barrier material affects the reaction speed of the plurality of sensing materials 111. By selecting different molecular barrier materials, the reaction speed is adjusted to meet the requirement.

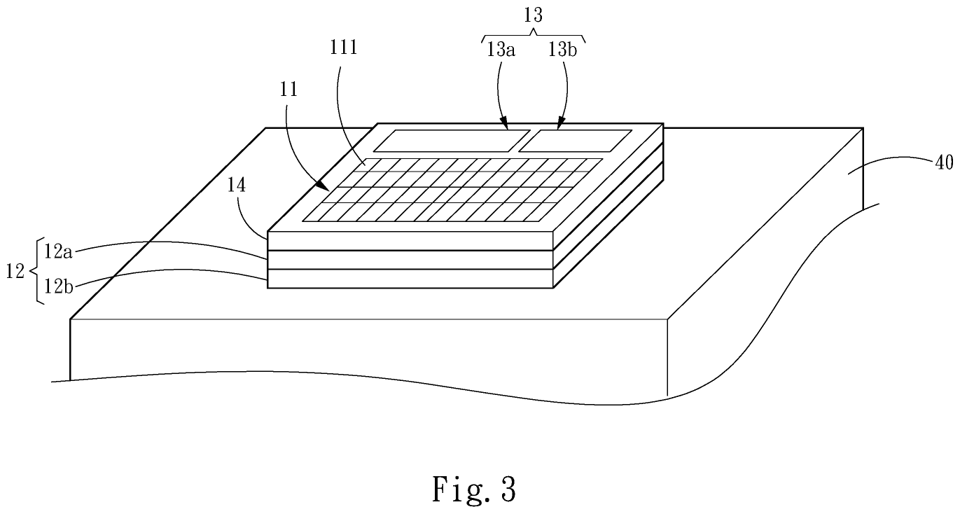

As shown in FIG. 2, in one embodiment, the material 12 which stores and releases molecules is a monolayer and comprises a porous structure. In another embodiment as shown in FIG. 3, the material 12 is a double layer including an odor molecule storage layer 12a and an odor molecule release layer 12b. The odor molecule storage layer 12a and the odor molecule release layer 12b are stacked with each other. The odor molecule storage layer 12a comprises a porous structure. A surface area of the porous structure is provided for the storage of the odor molecules, and the odor molecules are released in a diffusion controlled, osmotically controlled or chemically controlled manner. For example, the chemically controlled manner includes ion exchange resin and chemical bond breakage. In the embodiment, the at least one information display area 13 includes a first information display area 13a and a second information display area 13b. The first information display area 13a is a colorimetric card, and the second information display area 13b is a code. The code can be directly or indirectly associated to the item 40 to be tracked, and the code is defined by at least one piece of information of the item 40 to be tracked, such as records of traceability systems, quality information or an initial appearance. The code is a form of a character string, digits a combination of characters and digits, a one-dimensional bar code, a QR code, or the like.

The information processing device 20 includes an image capturing element 21 and a transceiver 22. In the embodiment, the information processing device 20 is a smart phone. The image capturing element 21 is a photographing module. The transceiver 22 is a network module. The information processing device 20 may be any electronic equipment with the image capturing element 21 and the transceiver 22, such as a personal computer or a tablet computer, but is not limited thereto. The server 30 and the information processing device 20 are connected in wireless communication. In the embodiment, the server 30 and the information processing device 20 are connected via an Internet 50.

In the invention, the material 12 pre-stores a known odor molecule. The known odor molecule here means that the color (i.e., a changed color) of the plurality of sensing materials 111 induced by the odor molecule is known before the comparison. Selection and combination of the odor molecule and the plurality of sensing materials 111 will affect the color (or the color gradation, hue magnitude) of the plurality of sensing materials 111, such as an RGB value, a CMYK value, or a hexadecimal color code. In the embodiment, a selection (or a combination) of the odor molecule and the plurality of sensing materials 111 is associated with at least one condition or parameter of the item 40 to be tracked, such as the item type, the manufacturer, production time, the production origin, sender, recipient, value, etc. By combining the odor molecule and the plurality of sensing materials 111, the odor molecule at a scheduled time or an odor molecule that changes over time. The odor molecule includes at least one metabolic molecule. Then, the odor molecule is diffused to the colorimetric sensor array 11 and chemically reacts with the plurality of sensing materials 111. After the chemical reaction, the plurality of sensing materials 111 will change from an initial color to an indicator color to enable the colorimetric sensor array 11 to appear a color pattern. Since the odor molecule is associated with the item 40 to be tracked, the color pattern is visually associated with odor information corresponding to the item 40 to be tracked. The information processing device 20 obtains the color pattern through the image capturing element 21, and the transceiver 22 transmits the color pattern to the server 30. The server 30 has a database. The color pattern is compared with the database to generate a comparison result. The information processing device 20 provides an identification result based on the comparison result corresponding to the item 40 to be tracked.

The odor molecule is regarded as a password associated with the item 40 to be tracked, the material 12 which stores and releases molecules is regarded as a carrier of the password, and the conversion of the color pattern and comparison of the database is regarded as interpretation of the password. For example, in the situation of package delivery, the odor molecule is pre-stored in the sensor 10 before delivery, and the identification result corresponding to the odor molecule is sent to a recipient. After the recipient receives the item 40 to be tracked, the item is verified through the identification result. Or, in the situation of items with timeliness, such as food materials or blood bags for medical purposes, the odor molecule is pre-stored in the sensor 10 before delivery, and the identification result corresponding to the odor molecule and scheduled time of arrival is sent to the recipient. After the recipient receives the item 40 to be tracked, the item is verified through the identification result.

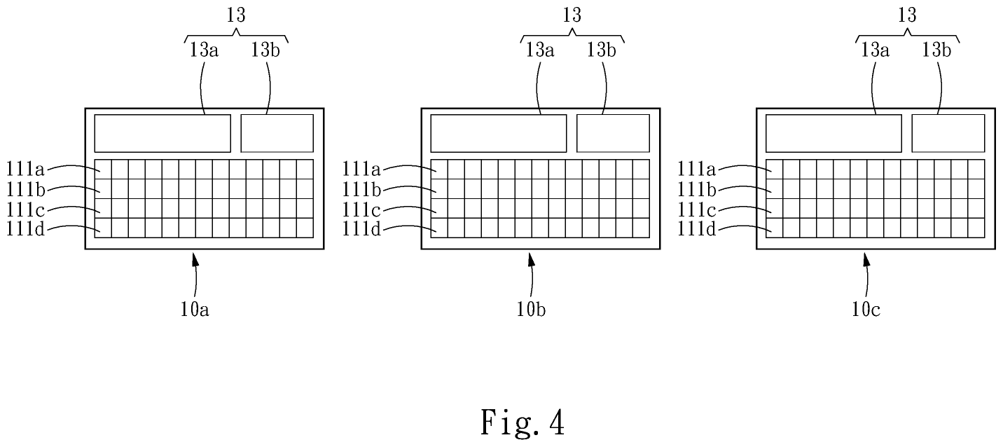

FIG. 4 is a schematic diagram of an application of one embodiment of the invention. The sensors 10a, 10b, and 10c are respectively chemical components in the odor molecule pre-absorbed by the material 12 will change over time, that is, the odor will change over time. The sensors 10a, 10b, and 10c represent different elapsed time of the same sensor. For example, the sensor 10a is 0 hour after the reaction, the sensor 10b is 1 hour after the reaction, and the sensor 10c is 2 hours after the reaction. When the odor molecule released by the material 12 reacts with the colorimetric sensor array 11 for 0 hour, the sensing material 111a, 111b, 111c, and 111d of the sensor 10a are pale red, pale yellow, pale blue, and pale green, respectively. When the odor molecule released by the material 12 reacts with the colorimetric sensor array 11 for 1 hour, the sensing material 111a, 111b, 111c, and 111d of the sensor 10b are dark red, dark yellow, dark blue, and dark green respectively. When the odor molecule released by the material 12 reacts with the colorimetric sensor array 11 for 1 hour, the sensing material 111a, 111b, 111c and 111d of the sensor 10c are light red, light yellow, light blue, and light green respectively.

By selecting different combinations of the odor molecule and the plurality of sensing materials, in other embodiments, the plurality of sensing materials at different spatial positions appears bright spots according to time. For example, when the odor molecule released by the material 12 reacts with the colorimetric sensor array 11 for 0 hour, the sensing material 111a of the sensor 10a is bright red, and the rest is in dark color. When the odor molecule released by the material 12 reacts with the colorimetric sensor array 11 for 1 hour, the sensing material 111b of the sensor 10b is bright yellow, and the rest is in dark color. When the odor molecule released by the material 12 reacts with the colorimetric sensor array 11 for 1 hours, the sensing material 111c of the sensor 10c is bright blue, and the rest is in dark color. In this way, the colorimetric sensor array 11 presents different expectable color patterns at different times, and the color patterns serve as a basis for decision making in logistics management.

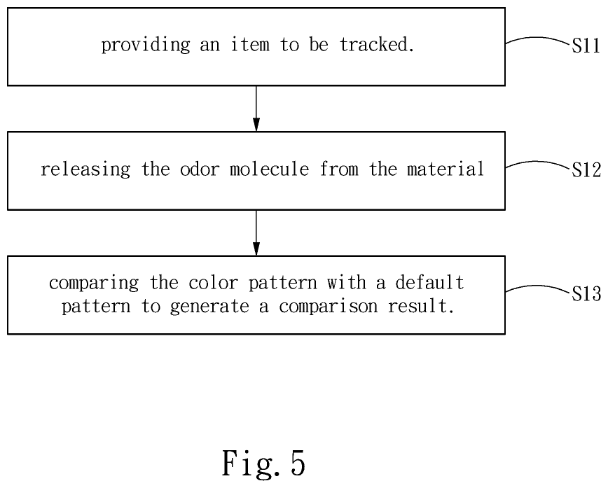

Referring to FIG. 5, a flow chart of steps of a method of one embodiment of the invention is illustrated, including the following steps.

In step S11: an item 40 to be tracked is provided. The item 40 to be tracked is provided with a sensor 10. The sensor 10 includes a colorimetric sensor array 11 and a material 12 which stores and releases molecules. The colorimetric sensor array 11 includes a plurality of sensing materials 111 sensing odor molecules. The material 12 pre-stores at least one known odor molecule. A selection (or a combination) of the odor molecules and the plurality of sensing materials 111 is associated with the item 40 to be tracked.

In step S12: the odor molecule is released from the material 12, and a reaction is occurred when at least one metabolic molecule of the odor molecule released from the material 12 is combined with the sensing materials 111 such that an initial color of the colorimetric sensor array is changed into an indicator color to present a color pattern.

In step S13: the color pattern is compared with a default pattern to generate a comparison result.

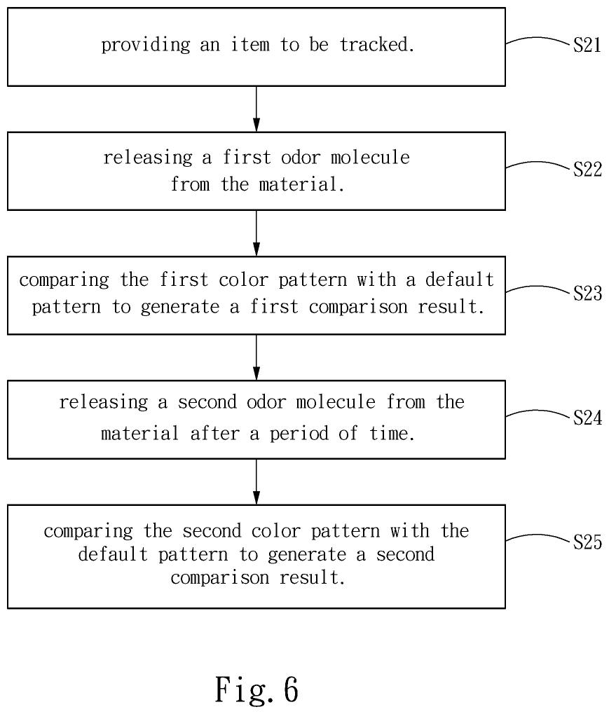

Referring to FIG. 6, a flow chart of steps of a method of another embodiment of the invention is illustrated, including the following steps.

In step S21: an item 40 to be tracked is provided. The item 40 to be tracked is provided with a sensor 10. The sensor 10 includes a colorimetric sensor array 11 and a material 12 which stores and releases molecules. The colorimetric sensor array 11 includes a plurality of sensing materials 111 to sense odor molecules. The material 12 pre-stores at least one known odor molecule. A selection (or a combination) of the odor molecules and the plurality of sensing materials 111 is associated with the item 40 to be tracked.

In step S22: a first odor molecule is released from the material 12, and a first reaction is occurred when at least one first metabolic molecule of the first odor molecule released from the material 12 is combined with the sensing materials 111 such that an initial color of the colorimetric sensor array is changed into a first indicator color to present a first color pattern. The first odor molecule is released from the odor molecule, and the odor molecule and the first odor molecule may be the same or different.

In step S23: the first color pattern is compared with a default pattern to generate a first comparison result.

In step S24: after a period of time, a second odor molecule is released from the material 12, and a second reaction is occurred when at least one second metabolic molecule of the second odor molecule released from the material 12 is combined with the sensing materials 111 such that the first indicator color of the colorimetric sensor array is changed into a second indicator color to present a second color pattern. The first odor molecule and the second odor molecule are different.

In step S25: the second color pattern is compared with the default pattern to generate a second comparison result.

Accordingly, in the invention, by use of the combination of the material which stores and releases molecules and the colorimetric sensor array, the odor molecule corresponding to the item to be tracked is pre-stored in the material, and the colorimetric sensor array provides macroscopic information. In this way, information associated with the item to be tracked is obtained via the color pattern, so as to manage the item to be tracked. The odor molecule stored in the material is hard to change, so that high level of safety is achieved. Furthermore, by selecting a proper material, the odor molecule can be designed to change over time and form different color patterns accordingly, thus further improving the safety of logistics management.

What is claimed is:

1. A system for logistics management based on odor molecules, comprising:
a sensor, mounted on an item to be tracked, wherein the sensor comprises a colorimetric sensor array and a material which stores and releases molecules, the material is configured to pre-store at least one known odor molecule, and the colorimetric sensor array comprises a plurality of sensing materials sensing the odor molecule, wherein a combination of the odor molecule and the sensing materials is associated with the item to be tracked;
an information processing device, comprising an image capturing element and a transceiver; and
a server, storing a database, wherein a communication connection is established between the server and the information processing device;
wherein the system is configured to perform the following steps:
releasing the odor molecule from the material, and a reaction occurred when at least one metabolic molecule of the odor molecule released from the material is combined with the sensing materials such that an initial color of the colorimetric sensor array is changed into an indicator color to present a color pattern;
capturing an image of the color pattern by the image capturing element of the information processing device;
comparing the image with the database to generate a comparison result; and
providing an identification result corresponding to the item to be tracked based on the comparison result by the information processing device.

2. The system according to claim 1, wherein the sensing materials comprises a color reagent, and the color reagent is selected from a group consisting of methyl red, Congo red, bromophenol blue, bromocresol purple, bromocresol green, cresol red, phenol red, thymolphthalein, resazurin, paranitrophenol, bromothymol blue, thymol blue, neutral red, crystal violet, 4-(4-nitrobenzyl) pyridine, pyrocatechol violet, chlorophenol red, nitrazine yellow, bromophenol red, in-cresol purple, Eriochrome black T, safranine, luciferin, Eosin yellow, Brilliant green, Titan yellow, Victoria blue B, carmine, litmus, curcumin, anthocyanin, alizarin red S, alizarin yellow R, indigo carmine, nile blue A, orange yellow G, Eosin B, 3,3′,5,5′,-tetraiodophenol sulfone phenolphthalein, bromoxylenol blue, phenol blue, disperse orange 25, acridine orange, disperse orange 3, disperse red 1, bromopyrogallol red, diaminodiphenyl sulfone, aminofluorescein, ammonium purpurate, 2,6-dichloroindophenol, sodium salts thereof, and mixtures thereof.

3. The system according to claim 2, wherein the sensing materials further comprises a molecular barrier material, and the molecular barrier material is selected from a group consisting of octadecanol, polyvinylpyrrolidone, polyvinyl formal, polyvinyl acetate resin, phenolic resin, epoxy resin, polybutene resin, polyethylene glycol, carbon black, carbon nanotubes, graphene, cellulose nanofibers, silicone compounds, and mixtures thereof.

4. The system according to claim 1, wherein the material comprises an odor molecule storage layer and an odor molecule release layer stacked on the odor molecule storage layer, and the odor molecule storage layer comprises a porous structure.

5. A method for logistics management based on odor molecules, comprising the following steps:
providing an item to be tracked, wherein the item to be tracked is provided with a sensor comprising a colorimetric sensor array and a material which stores and releases molecules, the colorimetric sensor array comprises a plurality of sensing materials sensing odor molecules, the material pre-stores at least one known odor molecule, and a selection of the odor molecule and the sensing materials is associated with the item to be tracked;
releasing the odor molecule from the material, and a reaction occurred when at least one metabolic molecule of the odor molecule released from the material is combined with the sensing materials such that an initial color of the colorimetric sensor array is changed into an indicator color to present a color pattern;
comparing the color pattern with a default pattern to generate a comparison result; and
providing an identification result corresponding to the item to be tracked based on the comparison result by the information processing device.

6. The method according to claim 5, wherein the sensing materials comprises a color reagent, and the color reagent is selected from a group consisting of methyl red, Congo red, bromophenol blue, bromocresol purple, bromocresol green, cresol red, phenol red, thymolphthalein, resazurin, paranitrophenol, bromothymol blue, thymol blue, neutral red, crystal violet, 4-(4-nitrobenzyl) pyridine, pyrocatechol violet, chlorophenol red, nitrazine yellow, bromophenol red, in-cresol purple, Eriochrome black T, safranine, luciferin, Eosin yellow, Brilliant green, Titan yellow, Victoria blue B, carmine, litmus, curcumin, anthocyanin, alizarin red S, alizarin yellow R, indigo carmine, nile blue A, orange yellow G, Eosin B, 3,3′,5,5′,-tetraiodophenol sulfone phenolphthalein, bromoxylenol blue, phenol blue, disperse orange 25, acridine orange, disperse orange 3, disperse red 1, bromopyrogallol red, diaminodiphenyl sulfone, aminofluorescein, ammonium purpurate, 2,6-dichloroindophenol, sodium salts thereof, and mixtures thereof.

7. The method according to claim 6, wherein the sensing materials further comprises a molecular barrier material, and the molecular barrier material is selected from a group consisting of octadecanol, polyvinylpyrrolidone, polyvinyl formal, polyvinyl acetate resin, phenolic resin, epoxy resin, polybutene resin, polyethylene glycol, carbon black, carbon nanotubes, graphene, cellulose nanofibers, silicone compounds, and mixtures thereof.

8. A method for logistics management based on odor molecules, comprising the following steps:
providing an item to be tracked, wherein the item to be tracked is provided with a sensor comprising a colorimetric sensor array and a material which stores and releases molecules, the colorimetric sensor array comprises a plurality of sensing materials sensing odor molecules, the material pre-stores at least one known odor molecule, and a selection of the at least one odor molecule and the sensing materials is associated with the item to be tracked;
releasing a first odor molecule from the material, and a first reaction occurred when at least one first metabolic molecule of the first odor molecule is combined with the sensing materials such that an initial color of the colorimetric sensor array is changed into a first indicator color to present a first color pattern;
comparing the first color pattern with a default pattern to generate a first comparison result;
releasing a second odor molecule from the material after a period of time, and a second reaction occurred when at least one second metabolic molecule of the second odor molecule released from the material is combined with the sensing materials such that the first indicator color of the colorimetric sensor array is changed into a second indicator color to present a second color pattern;
comparing the second color pattern with the default pattern to generate a second comparison result; and
providing an identification result corresponding to the item to be tracked based on the comparison result by the information processing device.

9. The method according to claim 8, wherein the sensing materials comprises a color reagent, and the color reagent is selected from a group consisting of methyl red, Congo red, bromophenol blue, bromocresol purple, bromocresol green, cresol red, phenol red, thymolphthalein, resazurin, paranitrophenol, bromothymol blue, thymol blue, neutral red, crystal violet, 4-(4-nitrobenzyl) pyridine, pyrocatechol violet, chlorophenol red, nitrazine yellow, bromophenol red, in-cresol purple, Eriochrome black T, safranine, luciferin, Eosin yellow, Brilliant green, Titan yellow, Victoria blue B, carmine, litmus, curcumin, anthocyanin, alizarin red S, alizarin yellow R, indigo carmine, nile blue A, orange yellow G, Eosin B, 3,3′,5,5′,-tetraiodophenol sulfone phenolphthalein, bromoxylenol blue, phenol blue, disperse orange 25, acridine orange, disperse orange 3, disperse red 1, bromopyrogallol red, diaminodiphenyl sulfone, aminofluorescein, ammonium purpurate, 2,6-dichloroindophenol, sodium salts thereof, and mixtures thereof.

10. The method according to claim 9, wherein the sensing materials further comprises a molecular barrier material, and the molecular barrier material is selected from a group consisting of octadecanol, polyvinylpyrrolidone, polyvinyl formal, polyvinyl acetate resin, phenolic resin, epoxy resin, polybutene resin, polyethylene glycol, carbon black, carbon nanotubes, graphene, cellulose nanofibers, silicone compounds, and mixtures thereof.
